(19) United States
(12) Patent Application Publication
(10) Pub. No.: US 2002/0024525 A1
(43) Pub. Date: Feb. 28, 2002

(54) Image encoding apparatus and method

(76) Inventor: Katsutoshi Ushida, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/941,779

(22) Filed: Aug. 30, 2001

(30) Foreign Application Priority Data
Aug. 31, 2000 (JP) 2000-264251

(51) Int. Cl. G06T 9/00

(52) U.S. Cl. 345/555

(57) ABSTRACT

There are provided an image encoding apparatus and method, which can achieve a low-cost, real-time encoding process by controlling a memory line controller and memory access controller to asynchronously and independently execute a typical prediction discrimination process and adaptive arithmetic coding process by a TP discriminator for reading out image data stored in a line memory for storing input image data, and making typical prediction discrimination in JBIG encoding for the input image data, and an adaptive arithmetic encoder for reading out image data stored in the line memory, and making adaptive arithmetic coding.

### FIELD OF THE INVENTION

The present invention relates to an image encoding apparatus and method for compressing data by adaptive arithmetic operations using typical prediction as a pre-process.

### BACKGROUND OF THE INVENTION

As a binary still image high-efficiency encoding scheme, JBIG (Joint Bi-level Image Group) has been recommended as ITU-T T.82 and T.85, and is prevalently applied to the fields that process binary still images such as copying machines, printers, facsimile apparatuses, and the like. This encoding scheme uses an adaptive arithmetic coding operation as entropy coding, and can attain high-efficiency coding not only of a character/line image but also of a pseudo halftone image unlike modified Huffman (MH), modified READ (MR), and modified modified READ (MMR) used in conventional G3 and G4 facsimile apparatuses and the like.

However, this adaptive arithmetic coding operation is high-efficiency encoding but requires a considerably larger arithmetic operation volume than runlength Huffman encoding/decoding used in MH, MR, and MMR since it must generate a template from surrounding pixels for each pixel to be encoded, make arithmetic operations for dividing several straight lines from the result of the template, and update a learning table.

In the aforementioned T.82 and T.85 recommendations, a pre-process such as a TP (typical prediction) process, DP (differential prediction) process, or the like is done to reduce the load imposed by such adaptive arithmetic coding operation, thereby reducing the number of pixels to be encoded, which must undergo the adaptive arithmetic coding operation.

FIG. 1 is a hardware block diagram of a typical sequential JBIG process. In this example, a 3-line template look-up process is done to generate a template for the adaptive arithmetic coding operation.

Referring to FIG. 1, reference numerals 101 to 104 denote line buffers which sequentially update and store image data for one line in synchronism with clocks (not shown), thus outputting image data for four lines including a line to be encoded and reference lines for template generation to a TP discriminator 105 and adaptive arithmetic encoder 107.

Image data input from an input terminal 100 at a rate of one pixel/clock in synchronism with transfer clocks (not shown) is stored in the line buffer 101. The line buffer 101 stores the data, and simultaneously reads out image data for the previous line and outputs it to the line buffer 102 in synchronism with the transfer clocks. The line buffer 102 stores the data output from the line buffer 101 in synchronism with the transfer clocks, and simultaneously reads out the stored data for the previous line and outputs it to the line buffer 103, as in the line buffer 101. In this manner, data are sequentially transferred to the line buffers 102, 103, and 104 while being updated, thus simultaneously extracting delayed data for four lines from the memories. In this example, the data read out from the line buffer 102 corresponds to the line to be encoded.

Reference numeral 105 denotes a TP (typical prediction) discriminator for comparing data read out from the line buffer 101 and data of the immediately above line read out from the line buffer 102 for one line so as to check if data for one line, which is read out from the line buffer 101 and is stored in the line buffer 102, allows typical prediction. A discrimination result indicating whether data allows typical prediction (LNTPy=0) or not (LNTPy=1) is output to a register 106 every time a process for one line is completed, and is held in the register to update the register value. Reference numeral 107 denotes an adaptive arithmetic encoder for receiving data for three lines, which are read out from the line buffers 102, 103, and 104, and generating template data corresponding to a pixel to be encoded using shift registers (not shown). The adaptive arithmetic encoder makes an adaptive arithmetic coding operation of the pixel to be encoded using this template data, thus generating and outputting encoded data. At the head of each line, a temporary pixel is computed using the register value held in the register 106, and an adaptive arithmetic coding operation is made using a fixed template therefor so as to encode the typical prediction result by adaptive arithmetic coding, thus generating and outputting encoded data. A detailed description of the adaptive arithmetic coding operation will be omitted.

However, since the prior art implements the TP (typical prediction) process by hardware, as shown in FIG. 1, line buffer memories for reference lines are required for the TP process, thus increasing the hardware scale. Furthermore, in the example shown in FIG. 1, since all the line buffer memory update process, TP discrimination process, and adaptive arithmetic coding operation are parallelly executed in synchronism with identical clocks, each line to be encoded requires a processing time given by the number of pixels for one line×clocks although the TP process that can reduce the number of pixels to be encoded if they allow typical prediction and that can achieve high-speed processing is used.

On the other hand, an encoding processing apparatus which is connected to a scanner or the like must encode input image data in real time. In this case, since the processing clocks of the scanner are independent from those of the encoder, a FIFO buffer for absorbing processing speed differences must be inserted between the scanner and encoding processor in addition to the line buffers, thus further increasing the hardware scale of the apparatus.

### SUMMARY OF THE INVENTION

The present invention has been made to solve the aforementioned problems, and has as its object to provide an image encoding apparatus and method, which can achieve a real-time encoding process with low cost by controlling to asynchronously and independently execute a typical prediction discrimination process and adaptive arithmetic coding process of the JBIG encoding process via line memories.

It is another object of the present invention to improve the processing speed of a line that allows typical prediction even in hardware, by asynchronously executing a typical prediction discrimination process at high speed prior to arithmetic coding when an adaptive arithmetic encoding processing apparatus is connected to receive image data via an image memory.

In order to achieve the above objects, according one aspect of the present invention, there is provided an image encoding apparatus comprising a plurality of line memories for storing input image data; discrimination means for reading out the image data stored in the plurality of line memories, and performing typical prediction discrimination in JBIG encoding of the input image data; encoding means for reading out the image data stored in the plurality of line memories, and performing adaptive arithmetic encoding; and control means for controlling access to the plurality of line memories between the discrimination means and the encoding means.

In order to achieve the above objects, according one aspect of the present invention, there is provided an image encoding method comprising the first control step of controlling access to a plurality of line memories for storing input image data; the second control step of controlling discrimination means for reading out the image data stored in the plurality of line memories, and performing typical prediction discrimination in JBIG encoding of the input image data; and the third control step of controlling encoding means for reading out the image data stored in the plurality of line memories, and performing adaptive arithmetic encoding, wherein the adaptive arithmetic encoding in the third control step is executed asynchronously with the typical prediction discrimination in the second control step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a hardware block diagram of a sequential JBIG process;

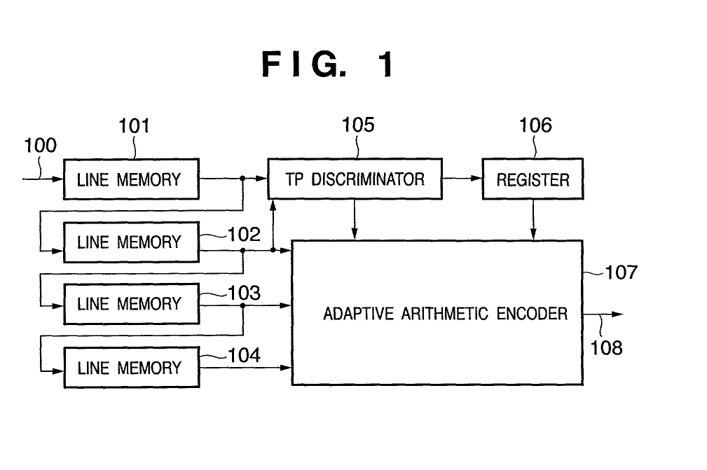

FIG. 2 is a block diagram showing the arrangement of an encoding apparatus according to an embodiment of the present invention;

FIG. 3 is a block diagram showing the detailed arrangement of a TP (typical prediction) discriminator 201 shown in FIG. 2;

FIGS. 4A to 4D are views for explaining access to a line memory 205 shown in FIG. 2; and

FIG. 5 is a chart showing the read/write timings of the TP discriminator 201 and an adaptive arithmetic encoder 206 by a line memory controller 203 according to an embodiment of the present invention.

### DETAILED DESCRIPTION OF THE PREFERRED EMBODIMENT

An embodiment according to the present invention will be described in detail hereinafter with reference to the accompanying drawings.

A TP (typical prediction) process in sequential JBIG of ITU-T T.85 described in the prior art will be described in detail below. In sequential JBIG, if the line to be encoded matches the immediately above line, it is determined that the line of interest is typical, and LNTPy=0 is set. If the line to be encoded is different from the immediately above line even by one pixel, it is determined that the line of interest is not typical, and LNTPy=1 is set. Upon encoding a head line of an image, or upon encoding a head line of a stripe in a stripe end data reset mode (SDRST), the immediately above line is assumed to be background color (white=0), thus making comparison for typical prediction.

In an actual image encoding/decoding process, adaptive arithmetic encoding/decoding is done using SLNTPy given by:

SLNTPy=!(LNTPy XOR LNTPy−1)

as a temporary pixel value in place of directly using the LNTPy value obtained by typical prediction.

For the uppermost line of an image, LNTPy−1=1 is set. Since an image of a line that allows typical prediction can be reconstructed from the immediately above line, only adaptive arithmetic coding using SLNTPy as a temporary pixel is done for that line, but no adaptive arithmetic coding is done for respective pixels of that line.

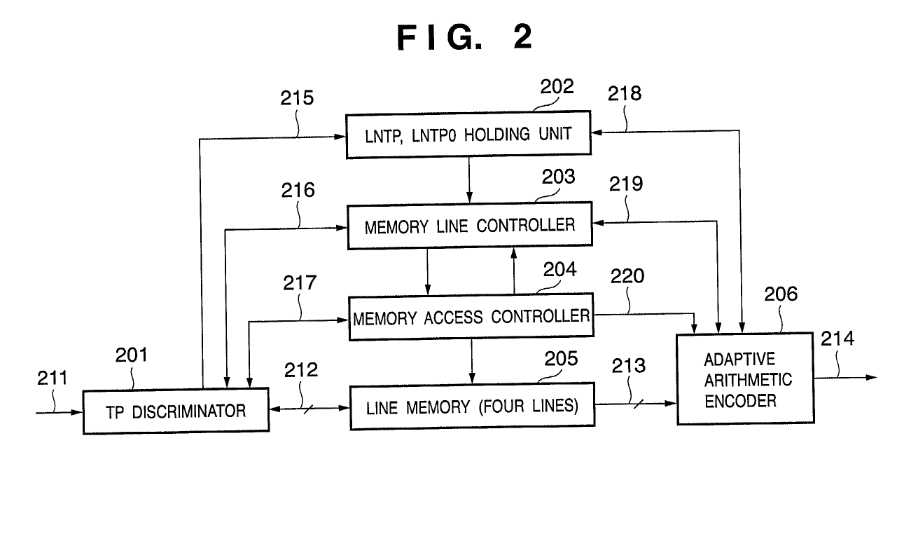

An encoding process of this embodiment will be described in detail below with reference to FIGS. 2 to 4.

FIG. 2 is a block diagram showing the arrangement of an encoding apparatus of this embodiment.

Image data is input from a scanner (not shown) in synchronism with pixel clocks or from an image memory (not shown) by DMA (direct memory access) to a TP (typical prediction) discriminator 201 via a signal line 211, after it undergoes a packing process to have the same data width (32 bits in this example) as a line memory 205 by a serial-to-parallel converter (not shown) if necessary. Upon receiving the image data that has undergone the packing process, the TP (typical prediction) discriminator 201 generates an access request to the line memory 205 to a memory access controller 204. In response to this access request, the memory access controller 204 generates a memory access cycle for storing image data input from the TP (typical prediction) discriminator 201 to the line memory 205 via a 32-bit data bus 212 in the line memory 205, and reading out image data of the immediately above line of input image data from the line memory 205 and outputting the image data to the TP (typical prediction) discriminator 201 via the 32-bit data bus 212.

The TP (typical prediction) discriminator 201 outputs the sequentially input image data to the line memory 205 via the 32-bit data bus 212, simultaneously reads out image data of the immediately above line from the line memory 205, and compares the input image data and that of the immediately above line. Upon completion of comparison of image data for one line, the TP (typical prediction) discriminator 201 outputs a discrimination flag (LNTPy) indicating whether or not the input line allows typical prediction to an LNTP, LNTP0 holding unit 202 via a signal line 215. In order to make typical prediction for background color=0 of a head line of an image or a stripe head line in the stripe end data reset mode, the input image data is compared with background color=0 simultaneously with the immediately above line, and it is parallelly checked if typical prediction is enabled for background color (white=0). Note that this parallel process is required since the TP (typical prediction) discrimination process and adaptive arithmetic coding process for the line to be encoded are asynchronously executed at different timings via the line memory 205.

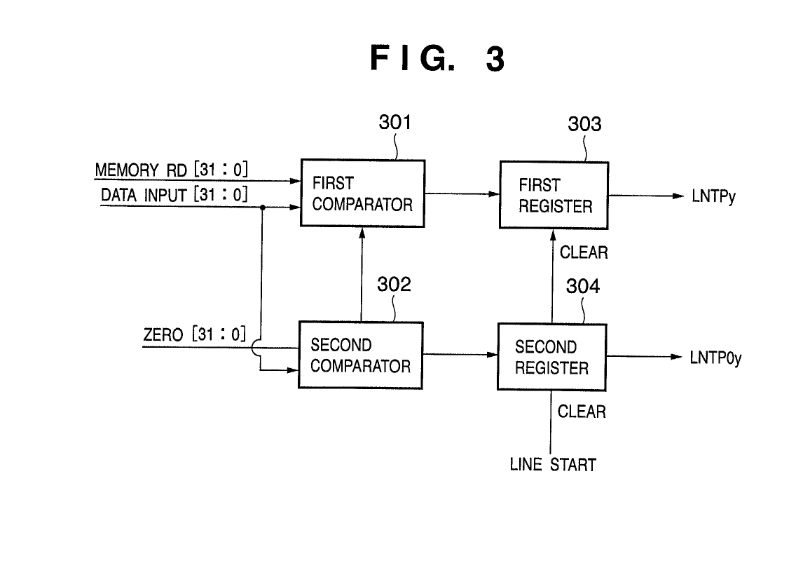

FIG. 3 is a block diagram showing the detailed arrangement of the TP (typical prediction) discriminator 201. Referring to FIG. 3, reference numeral 301 denotes a first comparator for comparing the data that has undergone the packing process with immediately above data read out from the line memory 205 in units of 32 bits. Reference numeral 302 denotes a second comparator for comparing the data that has undergone the packing process with background color=0 in units of 32 bits. Reference numeral 303 denotes a first register which is cleared to zero in response to a line start signal from a memory line controller 203 upon starting a 1-line comparison process, and is updated to 1 and holds that value when the comparison result of the first comparator 301 indicates mismatch even once during the 1-line process.

Reference numeral 304 denotes a second register which is cleared to zero in response to a line start signal from the memory line controller 203 upon starting a 1-line comparison process, and is updated to 1 and holds that value when the comparison result of the second comparator 302 indicates mismatch even once during the 1-line process. The values of the first and second registers 303 and 304 are output as LNTPy (comparison result with the immediately above line) and LNTP0y (comparison result with 0) to the LNTP, LNTP0 holding unit 202 via the signal line 215 at the time of completion of the 1-line comparison process.

Referring back to FIG. 2, the data set of the typical prediction discrimination results (LNTPy, LNTP0y) output via the signal line 215 is stored in a register group (not shown) of the LNTP, LNTP0 holding unit 202 via the signal line 215. After that, this data set is output to an adaptive arithmetic encoder 206 via a signal line 218. The LNTP, LNTP0 holding unit 202 has register groups corresponding to the number of memory line divisions, and holds data LNTPy and LNTP0y output from the TP (typical prediction) discriminator 201 in a register set corresponding to a line number of the line, image data of which is to be stored. Upon outputting the held values to the adaptive arithmetic encoder 206 via the signal line 218, the values of the register set having the line number corresponding to the line to be encoded are output. In this way, the typical prediction process and the line to be encoded are associated.

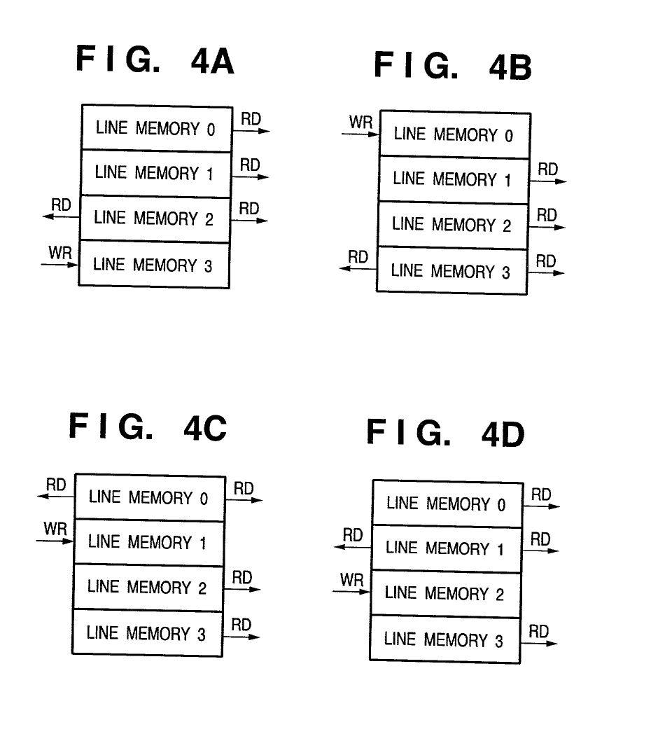

The memory line controller 203 controls pointers to line memories 0 to 3 to read out/write data from/in line memories 0 to 3 of the line memory 205, as indicated by arrows shown in FIGS. 4A to 4D. More specifically, for access from the TP (typical prediction) discriminator 201, pointers indicating the heads of lines of respective memory areas are held to access line memories corresponding to the left arrows (RD, WR) shown in FIGS. 4A to 4D. On the other hand, for access from the adaptive arithmetic encoder 206, pointers indicating the heads of lines of respective memory areas are held to access line memories corresponding to the right arrows (RD, WR) shown in FIGS. 4A to 4D. Respectively pointer values are output to the memory access controller 204 in accordance with access.

Since the positions of the aforementioned pointers are updated, as indicated by the arrows shown in FIGS. 4A to 4D, every time data for one line is processed, image data are sequentially read out from line memories 0, 1, and 2 and are output to the adaptive arithmetic encoder 206 in response to an access request from the adaptive arithmetic encoder 206, as indicated by the right arrows shown in FIGS. 4A to 4D. Likewise, when image data input from the signal line 211 is written in line memory 3 in response to an access request from the TP (typical prediction) discriminator 201, image data is read out from line memory 2 to read out data of the immediately above line, as indicated by the left arrows shown in FIGS. 4A to 4D.

In this way, when memory accesses are sequentially made in response to an access request from each block, and the process for one line is completed, the TP (typical prediction) discriminator 201 outputs a line update request due to line end to the memory line controller 203 via a signal line 216. The adaptive arithmetic encoder 206 outputs an update output due to line end to the memory line controller 203 via a signal line 219. Upon detection of completion of the 1-line processes of the respective blocks by the line update inputs from these blocks via the signal lines 216 and 219, the memory line controller 203 then updates pointers, as indicated by the arrows shown in FIG. 4B, and outputs a response signal indicating that the pointers have been updated to the respective blocks via the signal lines 216 and 219. In this manner, every time a 1-line process is complete, the pointers that manage the line memories are controlled to be updated from FIG. 4B to FIG. 4C, from FIG. 4C to FIG. 4D, and again to FIG. 4A, thus operating the line memory 205 as a FIFO memory having a ring buffer function.

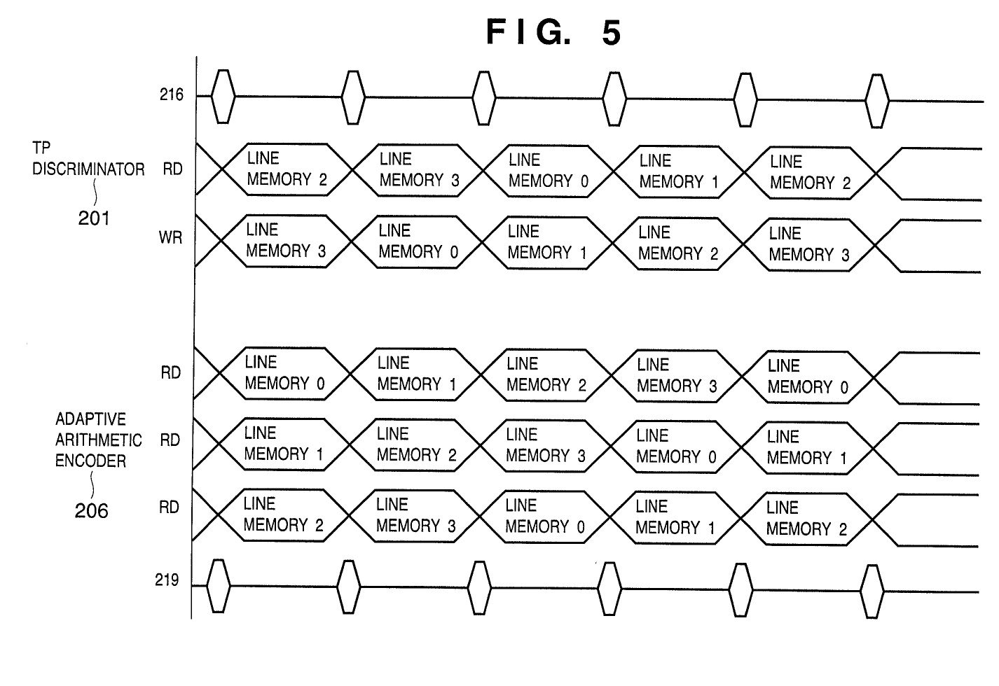

FIG. 5 shows the read/write timings of the TP discriminator 201 and adaptive arithmetic encoder 206 by the line memory controller 203 of this embodiment.

Since the TP discriminator 201 and adaptive arithmetic encoder 206 operate asynchronously in practice, they generate line update requests at asynchronous timings. In such case, the block that has completed the 1-line process earlier is controlled to wait in response to an update end response signal, thus making access arbitration for respective lines, and controlling overrun and underrun of the line memory 205.

The memory access controller 204 generates addresses of the line memory 205 on the basis of the line pointers indicating the heads of respective lines obtained from the memory line controller 203 and its internal counters (not shown; two counters are included, and are incremented in response to access requests from the respective blocks), and generates a memory access cycle to the line memory 205 in response to access request signals from the TP (typical prediction) discriminator 201 and adaptive arithmetic encoder 206.

That is, in response to an access request from the TP (typical prediction) discriminator 201 via the signal line 217, when the right of memory access to the TP (typical prediction) discriminator 201 is obtained by arbitration, an access response signal is output to the TP (typical prediction) discriminator 201 via the signal line 216, and a write cycle of input image data and a read cycle from the immediately above line are generated, as described above.

On the other hand, in response to an access request from the adaptive arithmetic encoder 206, when the right of memory access to the adaptive arithmetic encoder 206 is obtained by arbitration, an access response signal is output to the adaptive arithmetic encoder 206 via the signal line 219, and a read cycle of image data for a plurality of lines (three lines in this example) including the line to be encoded is generated, as described above.

In this fashion, since data are exchanged via the line memory 205, which has a FIFO buffer function, the TP (typical prediction) discriminator 201 and adaptive arithmetic encoder 206 can process in different processing units.

When start of encoding for one line is permitted by a response from the memory line controller 203, the adaptive arithmetic encoder 206 issues an access request of the line memory 205 to the memory access controller 204 so as to read out data of the reference lines and the line to be encoded. In response to this access request, the memory access controller 203 generates a memory access cycle to the line memory 205, and data of 32 bits×3 lines are read out and input via the 32-bit data bus 213. The input data are respectively input to three shift registers (not shown). Surrounding pixels of the pixel to be encoded are extracted from shift registers to generate a template. An adaptive arithmetic encoding operation is made using this template and data of the pixel to be encoded, thus outputting encoded data onto a signal line 214.

At the head of each line, the data set of LNTPy and LNTP0y corresponding to the line to be encoded are selected and read out from the aforementioned register group of the LNTP, LNTP0 holding unit 202 so as to encode a temporary pixel for typical prediction. The value of the temporary pixel is generated from some value of this data set based on a predetermined equation. The temporary pixel corresponding to typical prediction undergoes adaptive arithmetic coding using this temporary pixel and a fixed template corresponding thereto, thus similarly outputting encoded data onto the signal line 214.

These encoded data undergo a packing process in correspondence with the bus width of the signal line 214, and are stored in a code file memory (not shown). At this time, it is checked based on a counter (not shown) which is included in the adaptive arithmetic encoder 206 and is reset for each stripe process, if the line to be encoded is the head line of a stripe. When the encoding mode is the stripe end data reset mode, it is controlled to select the value LNTP0y for the head line or LNTPy for other lines. When the value LNTPy or LNTP0y is zero, since the line to be encoded need not be encoded any more, data read access from the line memory 205 is skipped, and a pointer update request signal is generated to the memory line controller 203, thus reducing the number of pixels to be encoded for a line that allows typical prediction, and achieving high-speed processing.

As described above, according to this embodiment, since the memory access controller 204 that manages lines on the basis of access requests from the blocks in units of n bits controls accesses from the TP (typical prediction) discriminator 201 and adaptive arithmetic encoder 206, the individual blocks can operate asynchronously, and the line memory 205 can be used as a reference buffer for typical prediction discrimination and template generation. At the same time, the line buffer 205 can be used as a FIFO for absorbing speed differences between an input unit (scanner) and the encoding processor, thus simplifying the apparatus. Since TP (typical prediction) discrimination is done in units of n bits by a block independent from the adaptive arithmetic coding process, high-speed encoding process for a line that allows typical prediction can be realized.

Note that the present invention may be applied to either a system constituted by a plurality of devices (e.g., a host computer, an interface device, a reader, a printer, and the like), or an apparatus consisting of a single equipment (e.g., a copying machine, a facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

To restate, according to this embodiment, since the typical prediction discrimination process and adaptive arithmetic coding process of the JBIG encoding process are controlled to be executed asynchronously and independently via the line memory, a real-time encoding process can be achieved at low cost.

As many apparently widely different embodiments of the present invention can be made without departing from the spirit and scope thereof, it is to be understood that the invention is not limited to the specific embodiments thereof except as defined in the appended claims.

What is claimed is:

1. An image encoding apparatus comprising:
a plurality of line memories for storing input image data;
discrimination means for reading out the image data stored in said plurality of line memories, and performing typical prediction discrimination in JBIG encoding of the input image data;
encoding means for reading out the image data stored in said plurality of line memories, and performing adaptive arithmetic encoding; and
control means for controlling access to said plurality of line memories between said discrimination means and said encoding means.

2. The apparatus according to claim 1, wherein said control means controls access to said plurality of line memories so as to asynchronously execute the typical prediction discrimination by said discrimination means and the adaptive arithmetic encoding by said encoding means.

3. The apparatus according to claim 1, wherein said plurality of line memories are used as a reference buffer for the typical prediction discrimination and template generation.

4. The apparatus according to claim 1, wherein access to said plurality of line memories is made in units of a predetermined number of bits.

5. The apparatus according to claim 1, wherein said discrimination means includes:
a first comparator for detecting by comparison in units of a predetermined number of bits whether or not all pixels of the input image data match data of an immediately above line read out from said line memory;
a second comparator for detecting by comparison in units of a predetermined number of bits whether or not the input image data is all “0”s; and
a register group for holding results of said first and second comparators in correspondence with said plurality of line memories.

6. The apparatus according to claim 5, wherein said encoding means comprises:
temporary pixel computation means for reading out values of the registers corresponding to a line to be encoded from said register group, and computing a value of a temporary pixel;
template generation means for generating a template from data read out from said line memory; and
an adaptive arithmetic encoder for executing an adaptive arithmetic encoding process on the basis of the temporary pixel value and a template corresponding to the temporary pixel or data to be encoded and the template corresponding to that data, and
either of the results of said first and second comparators corresponding to a line to be encoded are selected from said register group, the value of the temporary pixel is computed based on the selected results, and the temporary pixel is encoded by said adaptive arithmetic encoder.

7. An image encoding method comprising:
the first control step of controlling access to a plurality of line memories for storing input image data;
the second control step of controlling discrimination means for reading out the image data stored in said plurality of line memories, and performing typical prediction discrimination in JBIG encoding of the input image data; and
the third control step of controlling encoding means for reading out the image data stored in said plurality of line memories, and performing adaptive arithmetic encoding,
wherein the adaptive arithmetic encoding in the third control step is executed asynchronously with the typical prediction discrimination in the second control step.

8. An image encoding method comprising:
the first control step of controlling access to a plurality of line memories for storing input image data;
the second control step of controlling access to said plurality of line memories by discrimination means for reading out the image data stored in said plurality of line memories, and performing typical prediction discrimination in JBIG encoding of the input image data; and
the third control step of controlling access to said plurality of line memories by encoding means for reading out the image data stored in said plurality of line memories, and performing adaptive arithmetic encoding
wherein the first control step includes the step of controlling access to said plurality of line memories so as to perform accesses in the second and third control steps asynchronously.

9. The apparatus according to claim 1, wherein said plurality of line memories are FIFO buffers which serve as ring buffers by pointers that manage read/write access to said line memories.
